(19) United States
(12) Patent Application Publication
(10) Pub. No.: US 2026/0181298 A1
(43) Pub. Date: Jun. 25, 2026

(54) HEADSET STRUCTURE

(71) Applicant: OXTI Pte Ltd, Singapore (SG)

(72) Inventor: YU-LIN LIN, Singapore (SG)

(21) Appl. No.: 19/000,598

(22) Filed: Dec. 23, 2024

(51) Int. Cl. H04R 1/08; H04R 1/10

(52) U.S. Cl. CPC H04R 1/08; H04R 1/1008

(57) ABSTRACT

A headset structure includes a headphone, which is formed with a recessed compartment; and a wireless microphone, which is receivable and positionable in the recessed compartment. The wireless microphone includes a wireless transmitter. With such an arrangement of the wireless microphone, the distance between the earphone and the wireless microphone can be easily adjusted in order to solve the feedback sound problem and through such an arrangement of the recessed compartment, the wireless microphone is receivable and retained therein to thereby prevent the wireless microphone from being lost or dropped after being removed.

### BACKGROUND OF THE INVENTION

### (a) Technical Field of the Invention

The present invention relates generally to a headset structure, and more particularly to a headset structure with a wireless microphone.

### (b) Description of the Prior Art

A headset refers to a headphone with an attached microphone, and is commonly referring to audio input/output device comprising a combination of headphone and microphone.

Taiwan Patent No. 200840399 discloses a “headset structure device”, which includes a speaker device, a microphone device, a power supply device providing a supply of electrical power to the entire device, a housing mating and assembled with the previous devices, and two buckle assemblies arranged on the surface of the housing, so as to attach to a strip of a helmet strip with the two buckle assemblies to ease attaching and removing by the user.

However, the existing integrated headset suffers feedback sound problems. The feedback sound refers to sound leakage due to the distance between the microphone and the headphone being too close, or the volume being too loud. The sound from the headphone is received by the microphone and repeatedly fed back and amplified, resulting in sharp feedback sounds.

### SUMMARY OF THE INVENTION

To achieve the above objective, the present invention provides a headset structure, which comprises: a headphone, the headphone being formed with a recessed compartment; and a wireless microphone, the wireless microphone being receivable and positionable in the recessed compartment.

In the above, the headphone is of a double-earpiece style or a single-earpiece style.

In the above, the wireless microphone comprises a Bluetooth microphone.

In the above, the wireless microphone comprises a wireless transmitter.

With such an arrangement of the wireless microphone, the distance between the earphone and the wireless microphone can be easily adjusted in order to solve the feedback sound problem of the existing integrated headset, where the feedback sound refers to sound leakage due to the distance between the microphone and the headphone being too close, or the volume being too loud, so that the sound from the headphone is received by the microphone and repeatedly fed back and amplified to thereby result in sharp feedback sounds, and through such an arrangement of the recessed compartment, the wireless microphone is receivable and retained therein to thereby prevent the wireless microphone from being lost or dropped after being removed.

### BRIEF DESCRIPTION OF THE DRAWINGS

FIG. 1 is a schematic view showing a double-earpiece headset structure according to the present invention.

FIG. 2 is an exploded view showing the double-earpiece headset structure according to the present invention.

FIG. 3 is a first schematic view illustrating use of the two-earpiece headset structure according to the present invention.

FIG. 4 is a second schematic view illustrating the use of the two-earpiece headset structure according to the present invention.

FIG. 5 is a schematic view showing a single-earpiece headset structure according to the present invention.

### DETAILED DESCRIPTION OF THE PREFERRED EMBODIMENTS

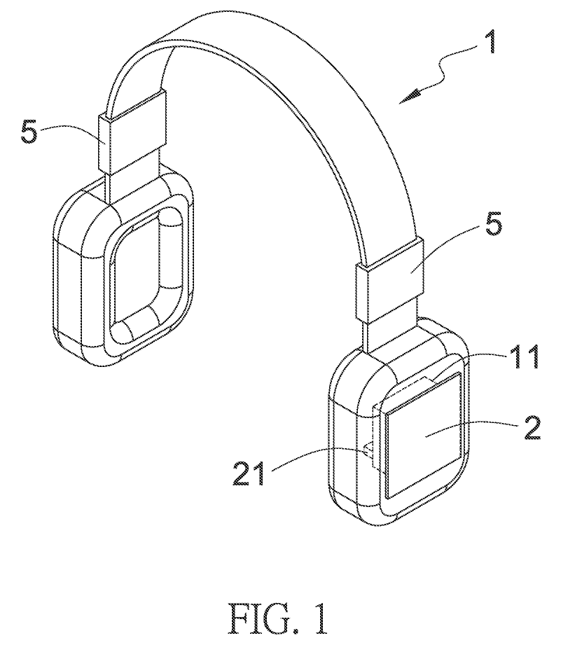

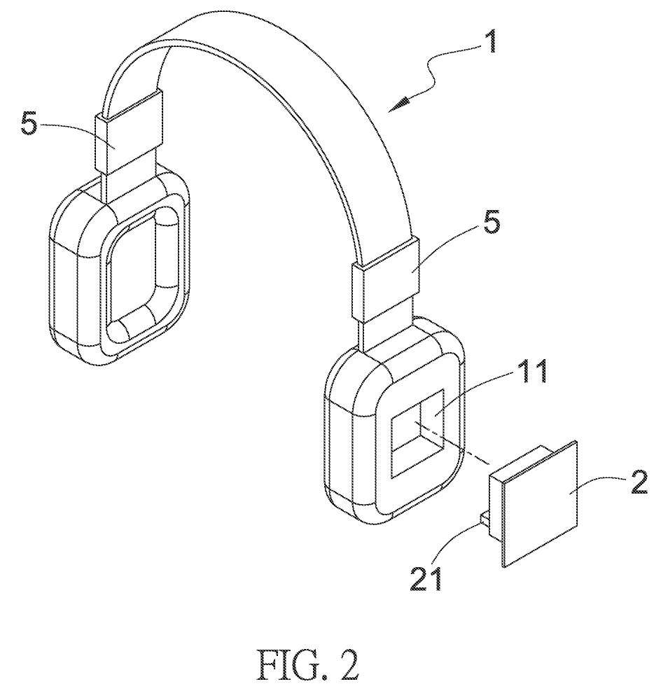

Referring to FIGS. 1 and 2, the present invention provides a headset structure, which comprises:

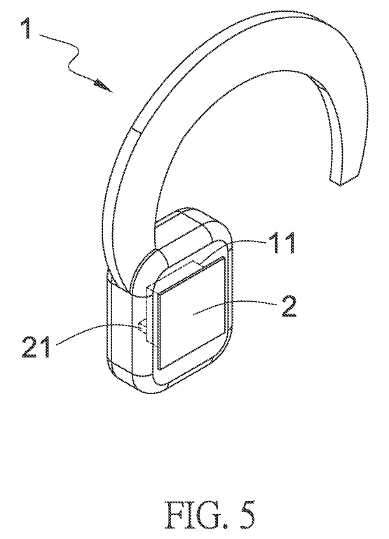

a headphone 1, wherein the headphone 1 is formed with a recessed compartment 11, wherein the headphone 1 can be of a double-earpiece style (shown in FIG. 1) or a single-earpiece style (shown in FIG. 5), and the headphone 1 comprises a head band 5, the head band 5 functioning for adjusting a length of the headphone 1; and

a wireless microphone 2, wherein the wireless microphone 2 is received and disposed in the recessed compartment 11, and the recessed compartment 11 has a shape corresponding to and mating a shape of the wireless microphone 2, so that the recessed compartment 11 retains the wireless microphone 2 in position in a more secured manner to prevent falling and detaching, and the wireless microphone 2 can be a detachable microphone and independently supplied with electrical power.

The wireless microphone 2 can be a Bluetooth microphone. The wireless microphone 2 comprises a wireless transmitter 21. The wireless transmitter 21 can be a Bluetooth transmitter.

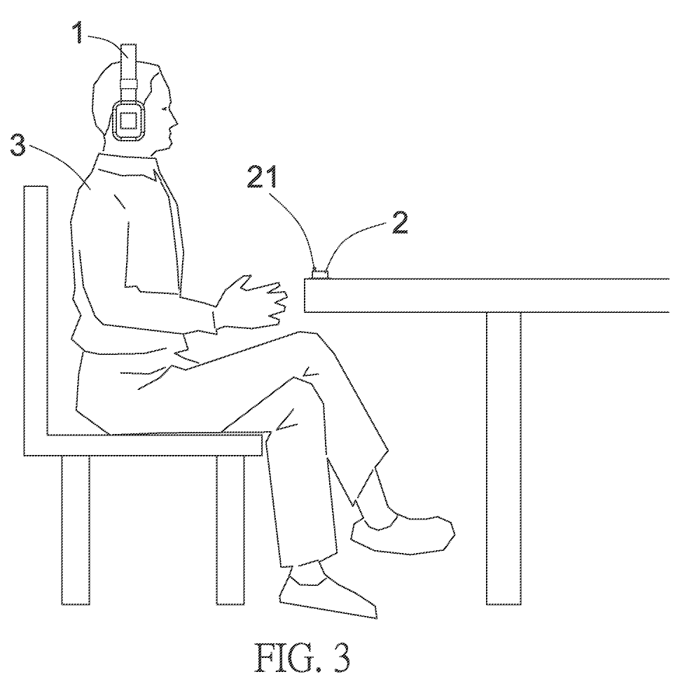

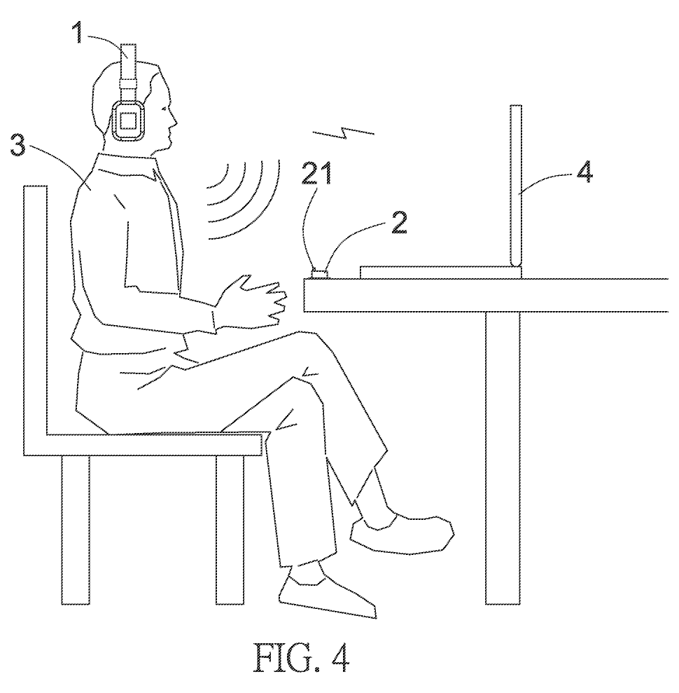

Referring to FIGS. 3 and 4, a user 3 removes the wireless microphone 2 from the recessed compartment 11 of the headphone 1 and places it on a desk, and connects the wireless microphone 2 to a computer device 4 (or a mobile device, such as a notebook computer, a tablet computer, or a smart phone, but not limited thereto), so that when the user 3 speaks, the sound of the user 3 is transmitted by the wireless transmitter 21 of the wireless microphone 2 to the computer device 4 to be transmitted through a network in connection with the computer device 4 to a recipient, and a responsive sound of the recipient is transmitted through the network back to the headphone 1 of the user 3.

The present invention is applicable to a scenario of sound recording or live performance by placing the wireless microphone 2 at a location closer to music instruments so as to use the wireless microphone 2 to achieve the best sound capture thereby providing better audio clarity. The wireless microphone 2 functions as a transmitter, and the headphone 1 functions as a receiver, so that with the detachable arrangement, interference between the headphone 1 and the wireless microphone 2 is reduced to thereby realize clear and uninterrupted sound transmission. This can actively reduce noise, improve the comfort of the user 3 when worn for a long time, and reduce ambient noise to create a listening environment as being personally in the scene.

With such an arrangement of the wireless microphone 2, the distance between the earphone 1 and the wireless microphone 2 can be easily adjusted in order to solve the feedback sound problem of the existing integrated headset, where the feedback sound refers to sound leakage due to the distance between the microphone and the headphone being too close, or the volume being too loud, so that the sound from the headphone is received by the microphone and repeatedly fed back and amplified to thereby result in sharp feedback sounds, and thus, the possibility of sound feedback is reduced to thereby improve the overall sound clarity, and through such an arrangement of the recessed compartment 11, the wireless microphone 2 is receivable and retained therein to thereby prevent the wireless microphone 2 from being lost or dropped after being removed.

I claim:

1. A headset structure, comprising:
a headphone, wherein the headphone is formed with a recessed compartment; and
a wireless microphone, wherein the wireless microphone is receivable and positionable in the recessed compartment.

2. The headset structure according to claim 1, wherein the headphone is of a double-earpiece style or a single-earpiece style.

3. The headset structure according to claim 1, wherein the wireless microphone comprises a Bluetooth microphone.

4. The headset structure according to claim 1, wherein the wireless microphone comprises a wireless transmitter.
